(19) United States
(12) Patent Application Publication
(10) Pub. No.: US 2002/0069264 A1
(43) Pub. Date: Jun. 6, 2002

(54) SYSTEM AND METHOD FOR BUILDING AND EXECUTING A NAVIGATION INSTRUCTION VIA CORRESPONDING SENTENCE CONSTRUCTION

(76) Inventor: SANDRO PASQUALI, SANTA FE, NM (US)

Correspondence Address: ERIK B. CHERDAK & ASSOCIATES, LLC, 11300 ROCKVILL PIKE, SUITE 906, ROCKVILLE, MD, 20852, US

(21) Appl. No.: 09/276,016

(22) Filed: Mar. 25, 1999

(51) Int. Cl. G06F 15/16

(52) U.S. Cl. 709/219

(57) ABSTRACT

System and method for building and executing a network navigation instruction via corresponding sentence construction that includes and involves a server data processing system having at least one database storing navigation options and corresponding navigation destination instructions. The system and method further include and involve a client data processing system coupled to the server data processing system via an electronic data network. The client data processing system is configured with at least one stored program. The stored program permits the client data processing system to access the server data processing system to load the navigation options and the corresponding navigation destination instructions into a local data storage facility, and to facilitate construction of a navigation sentence via selection of pre-configured sentence parts. The pre-configured sentence parts include a destination corresponding to at least one of the navigation options and the corresponding navigation destination instructions. The client data processing system retrieves network content based on the navigation sentence.

### BACKGROUND OF THE INVENTION

1. Field of the Invention

The present invention relates to systems and methods that are used to locate content via the Internet and World Wide Web (WWW).

2. Description of the Related Art

The Internet and the World Wide Web (WWW) have significantly impacted the way people receive information, purchase goods and services, and generally communicate. The Internet and WWW have facilitated whole content delivery industries that provide up-to-the-minute delivery (and sale) of information such as news, weather, sports scores, horoscopes, stock and securities information, advertising, etc. Many companies have recognized the great “gold-rush” nature of the Internet and have been quick to establish web-sites where people (a.k.a. “network surfers”) can visit to purchase books online, to receive specialized content such as investment and other reports, and to subscribe to content delivery services such as “electronic” newspapers and magazines. Despite the widespread use and acceptance of the Internet and the WWW, many industry analysts and insiders insist that our society has only begun to realize the advantages of publicly accessible network technologies and predict that our lives will only be further impacted by increased uses of the “Net.”

As a result of the Net's explosive acceptance and growth, the amount of content and material that may be accessed on the Net has mushroomed. Users of the Net can now search for, locate, and use their browser client applications to access network content that may be located at the far corners of the globe. To find such content (e.g., information about travel insurance, airline tickets, automobiles, boats, stocks, etc.), a network user can visit a WWW site such as www.yahoo.com to access and search through a hierarchical list of “links” related to a particular field of interest, or execute a keyword search against network content index databases. The results of such searches typically are lengthy lists of hyperlinks along with some type of descriptive text that attempts to summarize the nature of the content associated with each link. Unfortunately, a network user must exhaustively review the resultant links from such a “search engine” search to only possibly find desired content that is “on-target.” In fact, many WWW site operators have attempted, albeit unsuccessfully, to rid network searching of the “next 10 hits” phenomenon associated with having to review a lengthy list of often unrelated resulting links.

Unfortunately, despite their widespread use, search engines like or similar to those mentioned above continue to provide only indexed list and keyword search capabilities. As such search paradigms only provide network users with brute-force style ways of reviewing possibly accurate links to network content, network users have no way to quickly and accurately assess and access network content. That is, typical search engine type searches are limited to the robustness of index databases and the guesswork of a network user in specifying searchable keywords.

Thus, there exists a need to provide new and improved systems and methods to facilitate quick and accurate access to network content. Such systems and methods must allow effective and efficient deployment of network content search facilities without requiring Internet and WWW infrastructures and standards to change. And, to be viable, network users must be able to access network content without having to correctly guess accurate keywords to drive effective search engine searches and without having to review exhaustive lists of resultant hyperlinks.

### SUMMARY OF THE INVENTION

The present invention solves the above-described problems associated with finding and accessing network content. In solving such problems, several benefits are realized. For example, the present invention provides a hierarchical approach at indexing network content. The present invention allows such a hierarchical approach to be manifested in a WWW browser application in the form of easy-to-use drop-down selection boxes without having to specify special keywords and the like. Network users are now able to easily specify content search and location criteria, especially for commonly used searches and the like. And, WWW site providers can utilize the present invention to generate advertising revenue by selling access to positions within drop-down lists of available network destinations and simply selling the position itself.

Accordingly, in solving the aforementioned problems to deliver the above-described benefits, the present invention provides a system and method for building and executing a network navigation instruction via corresponding sentence construction that includes and involves a server data processing system having at least one database storing navigation options and corresponding navigation destination instructions. The system and method further include and involve a client data processing system that is coupled to the server data processing system via an electronic data network. The client data processing system is configured with at least one program. The at least one program causes the client data processing system to access the server data processing system to load the navigation options and the corresponding navigation destination instructions into a local data storage facility, and to facilitate construction of a navigation sentence via selection of pre-configured sentence parts. The pre-configured sentence parts include a destination corresponding to at least one of the navigation options and the corresponding navigation destination instructions. The client data processing system retrieves network content based on the navigation sentence.

According to another aspect of the present invention, provided is a method for facilitation network content searching. The method includes the steps of generating a software package that includes at least one network navigation destination instruction. The software package facilitates construction of a navigation sentence via selection of pre-configured sentence parts. The pre-configured sentence parts include at least one network navigation destination instruction. A serving step involves distributing the software package to a client data processing system to be run thereby.

The aforementioned and other aspects of the present invention are described in detail in the text that follows.

### BRIEF DESCRIPTION OF THE DRAWINGS

The present invention is described in detail below with reference to the following drawing figures, of which:

FIG. 1A is a block diagram of a network data processing environment and one in which a search sentence may be constructed in accordance with a preferred embodiment of the present invention;

FIG. 1B is a screen image that depicts structural aspects of the present invention and, in particular, search sentence construction structures provided in accordance with a preferred embodiment of the present invention to facilitate generation of destination navigation instructions;

FIG. 2 is a block diagram that depicts search sentence construction in accordance with a preferred embodiment of the present invention;

FIG. 3A is a flowchart that illustrates operations to be carried out to facilitate construction of a search sentence and a corresponding destination navigation instruction in accordance with a preferred embodiment of the present invention; and

FIG. 3B is the conclusion of the flowchart started in FIG. 3A.

### DETAILED DESCRIPTION OF THE PREFERRED EMBODIMENTS

The present invention is now discussed in detail with reference to the drawing figures that were briefly described above. Unless otherwise specified, like parts, systems, and processes are referred to with like reference numerals.

Glossary

The following terms may be used within the instant patent document to illustrate and define the novel features of the present invention. Accordingly, reference should be had to this Glossary for definitions of terms that are used to provide enabling disclosure related to the present invention's systems and methods for facilitating a windows based content manifestation environment within a WWW browser.

The terms that are capitalized below bear the following meanings.

Content is any form of digital data stream that may be supplied or sent to a computing system such as a personal computer. In the context of the present invention, content includes advertising information that may take the form of a data stream of video, audio, etc. Any media format that may be used to deliver active, dynamic content to a computer screen and other peripheral devices (e.g., sound systems, etc.) may be considered content in the context of the present invention.

The WWW is the world wide web and its associated protocols and related technologies which may be accessed via the Internet.

A WWW browser client is a software application that is operative to receive and process content to produce a corresponding output (e.g., to manifest text and images within a browser window displayed on a monitor device, etc.).

An Electronic Data Network is any type of network environment from which at least one coupled computer or computing system is configured to receive content such as HTML and related WWW content and to process the same to produce an appropriate output. An exemplary electronic data network is the Internet along with the WWW.

A window object is a Module or a Layer.

A Layer is a WWW browser content display section produced within a content manifestation environment (CME) including, but not limited to, any object within an HTML document that may be scaled, dragged, or otherwise operated upon such as an IMG object, a SPAN object, a DIV object, a form element, etc. and which may be associated with program logic such as within a script, etc. A layer has its own properties including, but not limited to, a name, etc. within an HTML rendition model such as those defined by DHTML standards. Additionally, a layer acts independently of other content within a particular HTML document.

A CME is a controllable WWW browser content display window provided by a WWW browser. For example, a CME is viewed as a dynamic window in which WWW content is normally displayed.

A Module (also referred to herein as a Window Module) is a layer having (1) a control section, and (2) a related content display section which may be manifested within a CME. A module may be recursively referenced in that a particular module provided in accordance with the present invention may include other modules. In other words, the present invention makes it possible to have window objects within window objects. The control section of a module may contain a name associated with the module, one or more module sizing icons, etc.

A DMOD is a draggable module much like a draggable type window provided within an operating system environment.

A TMOD is a tiled module much like a tiled type window provided within an operating system environment.

A Fixed Screen Region or FSR is an area of a screen environment such as within a CME in which content may flow based on Module operations, Java applet control, etc.

A Fixed Layer or FL is a layer having the same behavior as a FSR.

A Content Manifestation Layer or CML is a pop-up type layer much like a pop-up dialog box that can manifest content based on operations occurring within a Module (e.g., hyper-link traversal and/or occurrence of another event, etc.).

Module Controls or MCs control objects such as objects associated with screen icons that react to events (e.g., mouse clicks, mouse-overs, double-clicks, etc.) and which control attributes of a module (e.g., minimization, maximization, closure, resizing, etc.). The icons associated with such control objects will appear in a control section of a module.

The terms “dynamic manifestation” and “dynamic display” refer to the rendition of content such as advertising and marketing content received via an electronic data network such as the Internet and WWW within a module provided in accordance with the present invention. For example, dynamic manifestation includes the display of a full motion video stream within a window module in accordance with the present invention.

The aforementioned and defined terms may be made plural in the text found below (e.g., “DMODs”). Such terms may only be referred to in documentation incorporated by reference herein.

STRUCTURAL ASPECTS OF THE PRESENT INVENTION

In describing the present invention, the same may utilize technology which has been described and disclosed in commonly owned, co-pending U.S. patent application Ser. No. 09/234,297 filed Jan. 31, 1999, entitled “SYSTEM AND METHOD FOR FACILITATING A WINDOWS BASED CONTENT MANIFESTATION ENVIRONMENT WITHIN A WWW BROWSER” which application and content are hereby incorporated by reference.

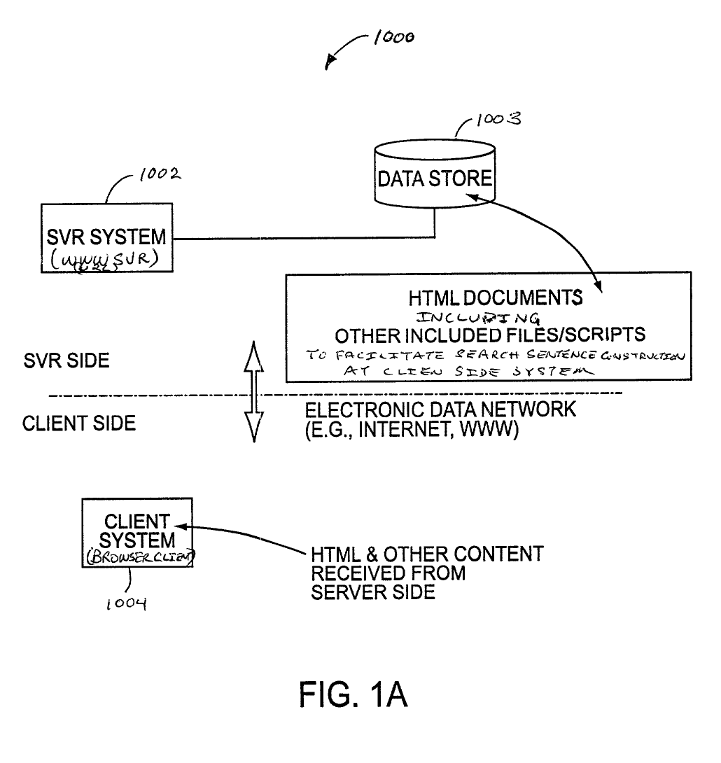

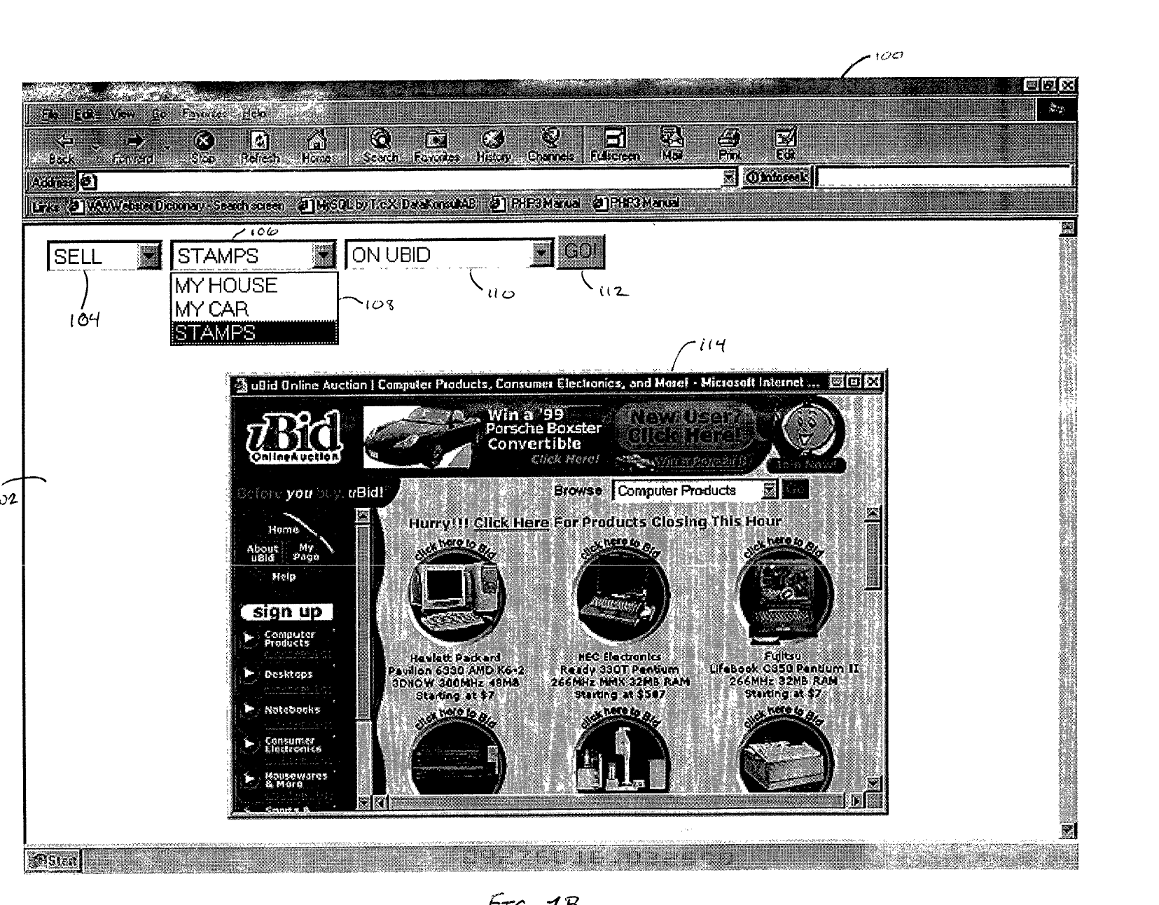

Referring now to FIG. 1A, depicted therein is a block diagram of a network data processing environment in which a search sentence may be constructed in accordance with a preferred embodiment of the present invention. In particular, network data processing system 1000 includes at least one server side system (e.g., a WWW or WEB SERVER system, etc.) 1002, a data store 1003, and at least one client side system 1004 such as personal data processing system (e.g., a personal computer, etc.). As indicated by the dashed line across the middle section of FIG. 1A, client side system 1004 is coupled to SVR SYSTEM 1002 via an electronic data network such as the Internet and WWW, an intranet, a private network, etc. The coupling of client system 1004 to server side system 1002 via such a network connection will be immediately understood by those skilled in the art.

Within data store 1003, HTML documents including included files and scripts such as javascript files, etc. are stored to constitute a software package that may be downloaded or otherwise distributed such as across a network connection. Such files may be downloaded in accordance with the present invention to facilitate search sentence construction at a client side system such as client system 1004 which runs in accordance with an appropriate network client such as a WWW browser client like or similar to NETSCAPE COMMUNICATOR V.4.5 which is manufactured and marketed by NETSCAPE CORPORATION. Such sentence construction is further described below with regard to FIGS. 1B, 2, 3A, and 3B.

In the context of the present invention server side system 1002 is intended to illustrate one or more network resource facilities such as server systems that may be addressed via separate network addresses (e.g., separate and distinct uniform resource locators (URLs)). For example, the box identifying SVR SYSTEM 1002 is intended to illustrate one or more server systems that may serve as a destination network content resource that may be accessed in accordance with a search sentence constructed based on the present invention.

Referring now to FIG. 1B, depicted therein is a screen image that illustrates structural aspects of the present invention and, in particular, search sentence construction structures provided in accordance with a preferred embodiment of the present invention.

In particular, screen image 100 depicts a WWW browser window or CME 102 of a running WWW browser application program such as one provided by the NETSCAPE COMMUNICATOR V.4.5 software package which is manufactured and marketed by NETSCAPE COMMUNICATIONS CORP. In CME 102, a WWW has been downloaded to the aforementioned WWW browser software application to be manifested on a display unit such as video monitor, etc. which is connected to a client computing system such as a personal computer or other data processing system.

In CME 102, sentence construction structures are provided to allow a user to select sentence parts to construct a search sentence that will correspond to a network location (e.g., a URL, etc.) from/at which a user will be able receive content, engage in electronic commerce, or otherwise utilize network resources. In the context of the present invention, search sentence construction is achieved via sentence part selection. Sentence parts, in the context of the present invention, include verbs (content access actions such as BUY, SELL, SEARCH, etc.), subjects (specific content such as CARS, HOUSES, STAMPS, etc.), and destinations (specific, pre-configured network locations that support or otherwise provide content and services related to selected verbs and subjects). Such sentence parts are pre-determined and are stored within database constructs (e.g., tables, hard-coded network documents, etc.). Once a search sentence has been constructed via user selection of sentence parts, a destination navigation instruction corresponding to the constructed sentence may be executed to access corresponding network content. The destination navigation instruction may be a URL or any other network resource that permits WWW browser traversal to locate or otherwise access network content and resources.

Accordingly, a verb selector pull-down box 104 has been provided to allow a user to select verbs and action type words related to locating network content. For example, verb selector 104 is shown after a user selected “SELL” as a particular type of action related to particular subjects and, possibly, at particular network locations.

After selecting a verb from verb selector pull-down box 104, search sentence construction is partially complete. That is, a user intends to “SELL” something at a network web site.

To further construct the search sentence, a subject selector pull-down box 106 has been provided to allow a user to select from a database of subjects related to locating network content. The available database entries presented in pull-down box 106 are listed for user perusal in drop-down box 108. That is, exemplary database entries for available subjects include, but are not limited to, “MY HOUSE,” “MY CAR,” and “STAMPS.”

Once a verb and subject have been selected by a user within CME 102, a destination may be selected. Such destination selection is achieved via destination pull-down box 110. Destination pull-down box 110 allows a user to select a network location from a database of pre-configured network locations to access in relation to the selected verb and subject. For example, a user may want to SELL STAMPS (e.g., historic postage stamps) at a network location known as UBID (WWW.UBID.coM).

After selecting the appropriate and available sentence parts to construct a search sentence, a user may submit the constructed search sentence by clicking a “GO” button 112. GO button 112 causes the user's browser, in accordance with the present invention, to access or otherwise traverse a network or other address to access a corresponding content or service source. For example, as shown within a browser window 114, a network location may be accessed and manifested therein. In particular, window 114 illustrates the UBID web site where the user may sell stamps in an auction format.

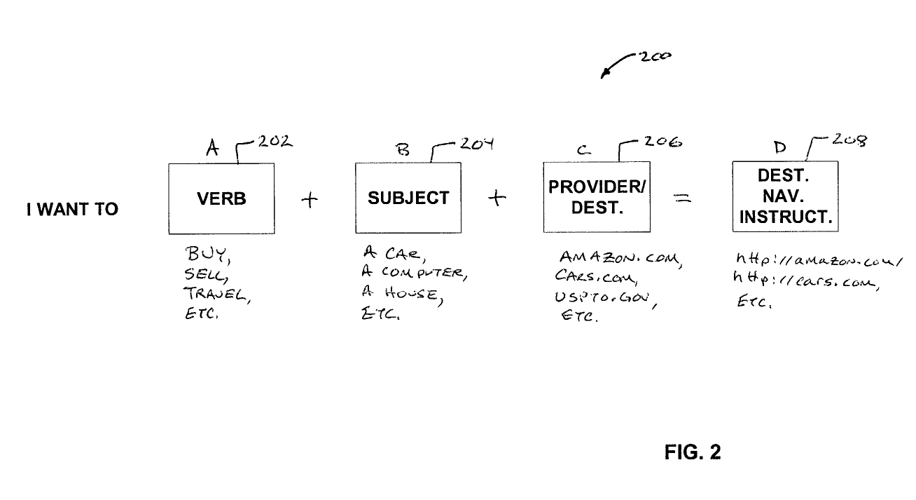

The construction of a search sentence that facilitates generation and/or determination of a destination navigation instruction is further illustrated in FIG. 2 to which reference is now made. In particular, FIG. 2 is a block diagram that depicts search sentence construction in accordance with a preferred embodiment of the present invention. As noted above with regard to FIG. 1, search sentence construction is achieved via user selection of sentence parts. That is, a search sentence is comprised of a verb (A), a subject (B), a provider/destination (C) to realize a destination navigation instruction (D) (e.g., URL, etc.). That is, a search sentence may be defined by the expression A+B+C=D.

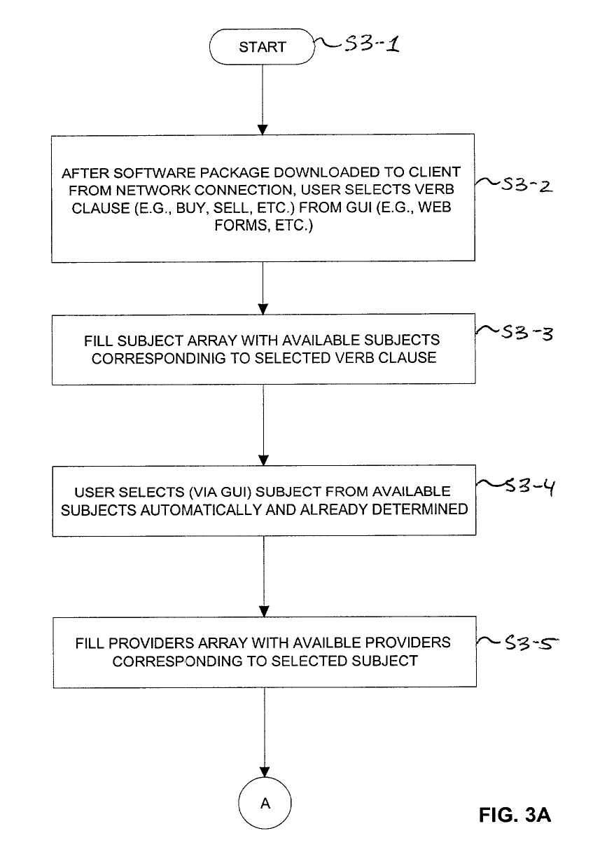

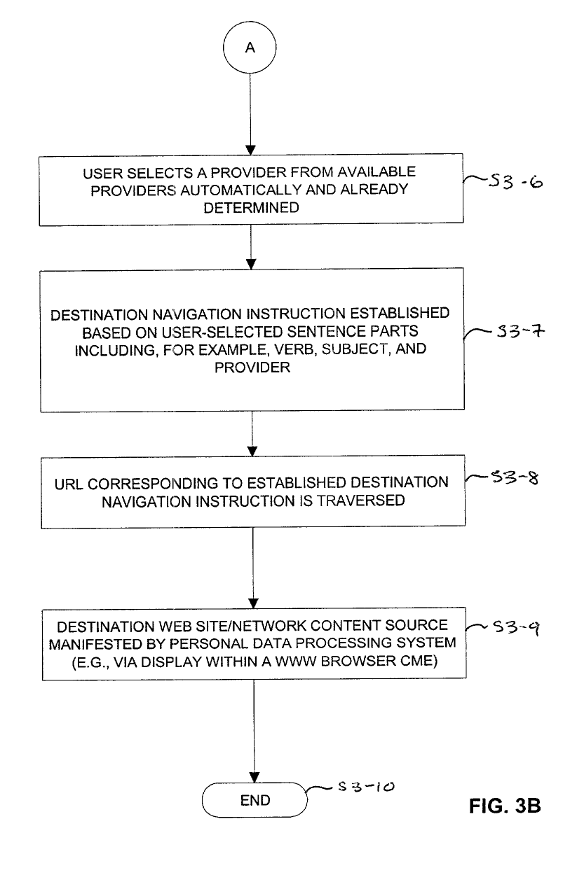

A process to facilitate generation and evaluation of the expression A+B+C=D is described below with regard to FIGS. 3A and 3B.

The aforementioned structural aspects of the present invention are further illustrated and explained with regard to several computer software programs that are listed below. Those familiar with hyper-text markup language (HTML) scripts and javascript coding will recognize the constructs listed in the computer software listings presented below after carefully reviewing the same. Moreover, such listings and corresponding files may be stored at a server system or facility (e.g., a WWW server system) and served to client systems such as personal computer systems coupled to the server facility via an electronic data network such as the Internet and WWW. Those familiar with modern networking technologies will immediately understand such storage and retrieval of files, and WWW resources.

### index.html

The listing entitled “index.html” found below forms the basis of a WWW site page that facilitates the constructs shown in FIG. 1. In particular, index.html may be loaded (e.g., such as via a download operation over an electronic data network such as the Internet and WWW, a file load from a local data store, etc.) into a WWW browser software application for processing thereby to manifest the constructs depicted in FIG. 1 and the operations described below with regard to FIGS. 3A and 3B.

<HTML>
<HEAD>
<TITLE>The Title of the Page</TITLE>
<script language=“Javascript”></script>
<script language=“Javascript”>
var IE4 = (document.all) ? 1 : 0;
var N4 = (document.layers) ? 1 : 0;
var IS4 = (IE4 && N4) ? 1 : 0;
</script>
<script language=“Javascript” src=“drop_downs.js”></script>
<script language=“Javascript” src=“menu_functions.js”></script>
</HEAD>
<BODY bgcolor=#ffffff>
<script language=“Javascript”>
with(top.document)
{

/***** first write the output image ********/
writeln(‘<form name=“theForm”>’);
/******* begin output of drop downs ***********/

writeln(‘<select name=“category” onchange=
“top.changeSubcat(this.form)”>’);

//write the zeroLevel names (1st select box)
for(yy=0; yy < zeroLevelNames.length; yy++)
writeln(‘<option value=’ + yy + ‘>’ + zeroLevelNames[yy]);

}

writeln(‘</select>’);

writeln(‘<select name=“subcat” onchange=“top.getLink(this.form)”>’);

writeln(‘<option value=“ ”>’ + filler);

for(zz=0; zz < dropWindowSize; zz++) // do the ‘added’ options

{
writeln(‘<option value=“ ”>’);

}

writeln(‘</select>’);

writeln(‘<select name=“links”>’);

writeln(‘<option value“ ”>’ + filler);

for(zz=0; zz < dropWindowSize; zz++) // do the ‘added’ options

writeln(‘<option value=“ ”>’);

}

writeln(‘</select><input type=BUTTON value=“GO!” onClick=
“top.doRef(this.form)”><br>’);

}// end with( )
</script>
</BODY>
</HTML>

### drop_downs.is

The listing entitled “drop_downs.js” as found below includes the javascript routines to facilitate the databases and/or stored values used to drive generation of a search sentence in accordance with a preferred embodiment of the present invention. Those familiar with javascript will immediately understand the constructs found in dropdowns.js after careful review of the same.

// set this to the max# of select options you want displayed
var drop WindowSize = 25;
var zeroLevel = new Array( );
var zeroLevelNames new Array(‘BUY’,‘SELL’,‘TRAVEL’);
var finals = new Array( );
var destinations = new Array( );
zeroLevel[0] =
new Array(‘A CAR’,‘A COMPUTER’,‘A BOOK’,‘A CD’);
zeroLevel[1] = new Array(‘MY HOUSE’,‘MY CAR’,‘STAMPS’);
zeroLevel[2] = new Array(‘BY PLANE’,‘BY TRAIN’);
finals[‘A CAR’] = new Array(‘FROM TOYOTA’,
‘FROM FORD’,‘FROM CHRYSLER’,‘FROM HYUNDAI’);
finals[‘A COMPUTER’] =
new Array(‘FROM COMPAQ’,‘FROM DELL’);
finals[‘A BOOK’] =
new Array(‘FROM AMAZON’,‘FROM B & N’,‘FROM BORDERS’);
finals[‘A CD’] = new Array(‘FROM CDNOW’,
‘FROM AMAZON’,‘FROM BMG’);
finals[‘MY HOUSE’] new Array(‘THROUGH REMAX’,
‘WITH CENTURY21’);
finals[‘MY CAR’] new Array(‘IN AUTO TRADER’);
finals[‘STAMPS’] = new Array(‘ON EBAY’,‘ON UBID’);
finals[‘BY PLANE’] = new Array(‘TO EUROPE’,‘TO CLUB MED’);
finnls[‘BY TRAIN’] = new Array(‘ON AMTRAK’,
‘THROUGH EUROPE’);
destinations[‘FROM TOYOTA’] = ‘www.toyota.com’;
destinations[‘FROM FORD’] = ‘www ford.com’
destinations[‘FROM CHRYSLER’] ‘www.chrysler.com’;
destinations[‘FROM HYUNDAI’] = ‘www.hyundai.com’;
destinations[‘FROM COMPAQ’] = ‘www.compaq.com’;
destinations[‘FROM DELL’] = ‘www.dell.com’;
destinations[‘FROM AMAZON’] = ‘www.amazon.com’;
destinations[‘FROM B & N’] ‘www.barnesandnoble.com’;
destinations[‘FROM BORDERS’] ‘www.borders.com’;
destinations[‘FROM CDNOW’] = ‘www.cdnow.com’;
destinations[‘FROM AMAZON’] = ‘www.amazon.com’;
destinations[‘FROM BMG’] = ‘www.bmg.com’;
destinations[‘THROUGH REMAX’] = ‘www.remax.com;
destinations[‘WITH CENTURY21’] = ‘www.century21.com’;
destinations[‘IN AUTO TRADER’] = ‘www.autotrader.com’;
destinations[‘ON EBAY’] = ‘www.ebay.com’;
destinations[‘ON UBID’] = ‘www.ubid.com’;
destinations[‘TO EUROPE’] = ‘www 1 800flycheap.com’;
destinations[‘TO CLUB MED’] = ‘www clubmed.com’;
destinations[‘ON AMTRAK’] = ‘www.amtrak.com’;
destinations[‘THROUGH EUROPE’] = ‘www.eurail.com’;

It is important to note that although drop_downs.js includes “hard-coded” database entries in the form of variable declarations and the like, the present invention is not so limited. In fact, any form of database of stored values that may be used to drive sentence part selection (e.g., tables containing field or column values and the like, variable declarations in a file, etc.) may be used instead. The use of such database constructs, in general, will be immediately understood by those skilled in the art after carefully reviewing the present invention.

### menu_functions.js

The listing entitled “menu_functions.js” as found below includes the javascript routines to allow drop-down boxes like or similar to those shown in FIG. 1 to be manifested within WWW browser CME 102. The drop_downs.js listing is included by reference into index.html as shown above. Those familiar with javascript will immediately understand the constructs found in menu_functions.js after careful review of the same.

```
var filler = ″;
var availableLink = 0;
// flag indicating whether full sentence has been realized
/* an arbitrary ‘filler to create a properly sized select box;
  * make sure it is big enough to accomodate your entries; as well,
  * try and keep your entries small; note how the setting of
  * this string varies from browser to browser.
*/
if(!top.IE4)
// none of this is necessary for IE4, which flows page automatically
{
filler =
‘&nbsp;&nbsp;&nbsp;&nbsp;&nbsp;&nbsp;&nbsp;&nbsp;
&nbsp;&nbsp;&nbsp;&nbsp;&nbsp;&nbsp;&nbsp;&nbsp;&nbsp;
&nbsp;&nbsp;&nbsp;&nbsp;&nbsp;&nbsp;&nbsp;&nbsp;&nbsp;’;
if(!IS4) // something extra for older browsers
{
filler +=
‘&nbsp;&nbsp;&nbsp;&nbsp;&nbsp;&nbsp;&nbsp;&nbsp;
&nbsp;&nbsp;&nbsp;&nbsp;&nbsp;&nbsp;&nbsp;&nbsp;’;
  }
}
function changeSubcat(form)
{
var x = form.category.selectedIndex;
```

form.subcat.options.length = 0 ; // clear this form
form.links.options.length = 0 ; // clear the next form
for(i=0; i<zeroLevel[x].length; i++)
{form.subcat.options[i] = new Option(zeroLevel[x][i],
zeroLevel[x][i]);}
form.subcat.selectedIndex = 0
// on every change of theForm.subcat,
update the first branch of theForm.links dropdown
getLink(top.document.theForm)

}
function getLink(form)
{

var selElem = form.subcat.options[form.subcat.SelectedIndex].text;
form.links.options.length = 0 ; // clear the form first
for(i=0; i<finals[selElem].length; i++)
{form.links.options[i] =
new Option(finals[selElem][i],finals[selElem][1]);}
form.links.selectedIndex = 0

availableLink = 1;
}
function doRef(form)

{
if(availableLink)
{
var thisDestination =

top.destinations[top.document.forms[0] .links.op-
tions[top.document.forms[0]links.selectedIndex].text];

var outUrl = (‘http://’ + thisDestination);
window.open(outUrl,“URL”,
“width=630,height=400,status=no,reslzable,scrollbars”);
}

}

With all of the structural aspects of the present invention as discussed above, it is important to note that although search sentence construction has been described with reference to sentence parts including a verb, a subject, and a destination to realize a destination navigation instruction (e.g., a URL, etc.), the present invention is not so limited. To the contrary, any number of or type of sentence parts may be used. For example, search sentences may be generated in response to user selection of just a verb, a verb and a destination, etc. There is no requirement that sentence parts, in the context of the present invention, take on any particular definition (e.g., a verb type part, etc.) or any particular meaning. Accordingly, the present invention it should be appreciated that the present invention is concerned with the drop-down nature of hierarchically arranged and available options to narrow-down content (e.g., network content, etc.) selection criteria.

Operational Aspects of the Present Invention

Referring now to FIGS. 3A and 3B, depicted therein is a flowchart that illustrates the operations that may be carried out to facilitate search sentence construction and corresponding destination navigation instruction generation in accordance with a preferred embodiment of the present invention. The process and operation steps discussed below are intended to be carried out or otherwise performed through use of a personal data processing system or other similar network client system, etc. that is outfitted with a WWW browser software package such as the NETSCAPE COMMUNICATOR V.4.5 which is manufactured by NETSCAPE COMMUNICATIONS CORP.

In particular, processing and operations start at step S3-1 and immediately proceed to step S3-2.

At step S3-2, after receiving computer software of the type described and listed above, a user may select a verb clause (e.g., “BUY,” “SELL,” etc.). Accordingly, after step S3-2 is performed, the “A” part of the expression A+B+C=D as described above with regard to FIG. 2 is complete.

Next, at step S3-3, subject database entries are entered or otherwise filled into an array or other data structure that corresponds to drop-down box 104 (FIG. 1). Such database entries are available subject entries which correspond to the verb sentence part selected in step S3-2.

Next, at step S3-4, the user may select (e.g., from a drop-down box, etc.) a particular subject from listed, available subjects as established during step S3-3. Accordingly, after step S3-4 is performed, the “B” part of the expression A+B+C=D as described above with regard to FIG. 2 is complete.

Next, at step S3-5, available providers are entered or otherwise filled into an array or other data structure that corresponds to drop-down box 106 (FIG. 1). Such database entries are available providers entries which correspond to the subject selected by the user at step S3-4.

Processing and operations continue at step S3-6 at the top of FIG. 3B to which reference is now made.

At step S3-6, the user selects a provider from the available providers automatically inserted into the aforementioned database structure (e.g., an array, etc.). Accordingly, after step S3-6 is performed, the “C” part of the expression A+B+C=D as described above with regard to FIG. 2 is complete.

Next, at step S3-7, a destination navigation instruction (e.g., an URL, etc.) is held as established based on user-selected sentence parts including a verb, a subject, and a provider. Hence, the destination navigation instruction that is generated as a result of the search sentence construction operations described above, is the “D” in the expression A+B+C=D that was discussed in regard to FIG. 2.

Next, at step S3-8, an URL, for example, corresponding to the established destination navigation instruction that was generated as described above is traversed or otherwise processed to access corresponding content, web sites, network locations and resources, etc. Of course, our URL need not necessarily point to a remote location, and instead may point to a local drive, file, etc. for content.

Next, at step S3-9, a destination WWW site or other network content is downloaded in accordance with the destination navigation instruction to the WWW browser application for manifestation thereby. For example, content received from a network connection may be displayed on a visual display device connected to a personal data processing system.

Processing and operations end at step S3-10.

Thus, having fully described the present invention by way of example with reference to attached drawing figures, it will be readily appreciated that many changes and modifications may be made to the invention and to any of the exemplary embodiments shown and/or described herein without departing from the spirit or scope of the invention, which is defined in the appended claims.

What is claimed is:

1. A system for building and executing a network navigation instruction via corresponding sentence construction, comprising:
a server data processing system having at least one database storing navigation options and corresponding navigation destination instructions; and
a client data processing system coupled to the server data processing system via an electronic data network and configured with at least one program, said at least one program causes said client data processing system to access said server data processing system to load said navigation options and said corresponding navigation destination instructions into a local data storage facility, to facilitate construction of a navigation sentence via selection of pre-configured sentence parts, said pre-configured sentence parts including a destination corresponding to at least one of said navigation options and said corresponding navigation destination instructions,
whereby said client data processing system retrieves network content based on said navigation sentence and said destination thereof.

2. The system according to claim 1, wherein said client data processing system retrieves said network content via a WWW site and said electronic data network.

3. The system according to claim 1, wherein said destination instructions include links to content accessible via said electronic data network, said at least one program further configured to traverse said links.

4. The system according to claim 3, wherein said links are uniform resource locators (URLs).

5. The system according to claim 1, wherein selection of said sentence parts is realized via pull-down dialogs within a graphical user interface provided within said client data processing system.

6. The system according to claim 5, wherein said graphical user interface is provided within a WWW site review window of a running WWW browser software package.

7. A network content search engine adapted to facilitate Internet and WWW content searching, comprising:
a software package configured to be downloaded to a client data processing system, said software package including at least one network navigation destination instruction, said software package facilitating client-side construction of a navigation sentence via selection of pre-configured sentence parts, said pre-configured sentence parts including said at least one network navigation destination instruction,
whereby network content is retrieved based on said navigation sentence and said at least one network navigation destination instruction.

8. The network content search engine according to claim 7, wherein said network navigation destination instruction is a uniform resource locator (URL).

9. The network content search engine according to claim 7, wherein selection of said pre-configured sentence parts is realized via pull-down dialogs within a graphical user interface provided within a client data processing system.

10. The system according to claim 9, wherein said graphical user interface is provided within a WWW site review window of a running WWW browser software package.

11. A method of using a network content search engine, comprising the steps of:
(a) accessing a first network location to receive a software package, said software package facilitating construction of a navigation sentence via selection of pre-configured sentence parts, said pre-configured sentence parts including said at least one network navigation destination instruction; and
(b) accessing a second network location based on said at least one network navigation destination instruction.

12. The method according to claim 11, wherein step (a) is initiated within a client-side system running in accordance with a WWW browser software application.

13. The method according to claim 11, wherein step (b) is initiated within a client-side system running in accordance with a WWW browser software application.

14. The method according to claim 11, wherein said at least one network navigation destination instruction is a uniform resource locator (URL).

15. The method according to claim 11, wherein said software package includes said at least one network navigation destination instruction.

16. A method for facilitation network content searching, comprising the steps of:
generating a software package, said software package including at least one network navigation destination instruction, said software package facilitating construction of a navigation sentence via selection of pre-configured sentence parts, said pre-configured sentence parts including said at least one network navigation destination instruction; and
serving said software package to a client data processing system to be run thereby.

17. A software system adapted to be downloaded to a network client system running in accordance with a network client application to facilitate access to a network content source, comprising:
a database module having a database of destination navigation instructions, said destination navigation instructions corresponding to network content sources; and
a search sentence construction module permitting construction of a search sentence corresponding to at least one of said destination navigation instructions, said at least one destination navigation instruction adapted to be processed within said network client application to access said network content source.

18. The software system according to claim 17, wherein said database module includes values corresponding to sentence parts that may be assembled to correspond to said destination navigation instructions.

19. The software system according claim 17, wherein said database module includes a reference to a network resource having values corresponding to sentence parts that may be assembled to correspond to said destination navigation instructions.

20. The software system according to claim 17, wherein said search sentence construction module includes instructions to control said network client application to permit graphical user interface (GUI) selection of sentence parts.
